(19) United States
(12) Patent Application Publication
(10) Pub. No.: US 2014/0171124 A1
(43) Pub. Date: Jun. 19, 2014

(54) SAVING GPS POWER BY DETECTING INDOOR USE

(71) Applicant: Stephen D. Goglin, Hillsboro, OR (US)

(72) Inventor: Stephen D. Goglin, Hillsboro, OR (US)

(21) Appl. No.: 13/997,833

(22) PCT Filed: Mar. 30, 2012
(86) PCT No.: PCT/US12/31478

§ 371 Date: Jun. 25, 2013

(51) Int. Cl. H04W 52/02; H04W 4/02

(52) U.S. Cl. CPC H04W 52/0225; H04W 4/02
USPC 455/456.4; 455/556.1

(57) ABSTRACT

In accordance with embodiments disclosed herein, there are provided systems, apparatuses, and methods for saving GPS power by detecting indoor use. For example, in one embodiment, such means may include means for receiving a first reading of light within a visible spectrum of electromagnetic radiation; means for receiving a second reading of light within an infrared spectrum of electromagnetic radiation; means for selecting an indoor environmental state when (a) the first reading of light within the visible spectrum of electromagnetic radiation is above a first threshold and (b) the second reading of light within the infrared spectrum of electromagnetic radiation is below a second threshold; and means for transitioning a Global Positioning System (GPS) sensor to a power savings mode based on the indoor environmental state being selected. For instance, such a technique may determine the GPS sensor is inside based on relatively low infrared readings and relatively high visible spectra readings, and responsively transition the GPS sensor into a more power efficient mode.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The subject matter described herein relates generally to the field of computing, and more particularly, to systems, apparatuses, and methods for saving GPS power by detecting indoor use.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed subject matter.

A smartphone is a mobile phone built on a mobile computing platform with more advanced computing ability and connectivity than a feature phone. Modern smart phones combine the functions of a personal digital assistant (PDA) with that of a mobile phone or camera phone.

Recent generations of smartphones incorporate increasingly sophisticated computing architecture, software, interfaces, and sensors, so as to enable a vast array of capabilities.

Arguably, the Achilles heal of any modern portable electronic device is the limited capacity for storing energy within an electrical battery configured with the portable electronic device.

Designers of such devices are faced with the constant problem of limited battery power and ever increasing demands for energy usage, whether the issue is one of incorporating a battery's size and mass into the small form factor of a portable device or the trade-off that must be struck between increased computing capability and energy consumption versus operating longevity for such a device. Efficient use of the limited available battery power for any given portable device is therefore an important design objective.

The present state of the art may therefore benefit from the systems, apparatuses, and methods for saving GPS power by detecting indoor use as described herein.

### BRIEF DESCRIPTION OF THE DRAWINGS

Embodiments are illustrated by way of example, and not by way of limitation, and will be more fully understood with reference to the following detailed description when considered in connection with the figures in which:

FIG. 1A illustrates an exemplary architecture in accordance with which embodiments may operate;

FIG. 1B illustrates an alternative exemplary architecture in accordance with which embodiments may operate;

FIG. 1C illustrates an alternative exemplary architecture in accordance with which embodiments may operate;

FIG. 2 illustrates a responsivity graph in accordance with which embodiments may operate;

FIG. 3 illustrates an alternative exemplary embodiment;

FIG. 4 is a block diagram 400 of an embodiment of tablet computing device, a smart phone, or other mobile device in which touchscreen interface connectors are used in accordance with the described embodiments; and

FIG. 5 is a flow diagram illustrating a method for saving GPS power by detecting indoor use in accordance with described embodiments.

### DETAILED DESCRIPTION

Described herein are systems, apparatuses, and methods for saving GPS power by detecting indoor use. For example, in one embodiment, such means may include means for receiving a first reading of light within a visible spectrum of electromagnetic radiation; means for receiving a second reading of light within an infrared spectrum of electromagnetic radiation; means for selecting an indoor environmental state when (a) the first reading of light within the visible spectrum of electromagnetic radiation is above a first threshold and (b) the second reading of light within the infrared spectrum of electromagnetic radiation is below a second threshold; and means for transitioning a Global Positioning System (GPS) sensor to a power savings mode based on the indoor environmental state being selected. For instance, such a technique may determine the GPS sensor is inside based on relatively low infrared readings and relatively high visible spectra readings, and responsively transition the GPS sensor into a more power efficient mode. Alternatively, the technique may determine, based on a relatively high visible spectra and a relatively high infrared spectra, that the GPS sensor is outdoors and responsively transition the GPS sensor to a normal operating state, such as a full power mode.

GPS sensors on many devices become practically useless when operating indoors but will nevertheless continue to consume valuable energy reserves and deplete the battery of portable devices.

Generally speaking, a GPS sensor operates in conjunction with the Global Positioning System (GPS) which is a network of space-based satellites that provide location and time information to GPS sensor enabled devices on the Earth. Because the sensors operate in conjunction with the satellites, it is necessary that the sensors acquire an unobstructed line of sight to such satellites. Most algorithms require line of sight to four or more such GPS satellites, and it is for these reasons that operation of a GPS sensor while indoors is wasteful in terms of energy usage as acquiring the required GPS signals is likely futile.

A mechanism to determine when a device is operating indoors and automatically places such a GPS sensor into a power savings mode could save valuable energy reserves, especially on portable electronic devices with limited battery supply.

In the following description, numerous specific details are set forth such as examples of specific systems, languages, components, etc., in order to provide a thorough understanding of the various embodiments. It will be apparent, however, to one skilled in the art that these specific details need not be employed to practice the embodiments disclosed herein. In other instances, well known materials or methods have not been described in detail in order to avoid unnecessarily obscuring the disclosed embodiments.

In addition to various hardware components depicted in the figures and described herein, embodiments further include various operations which are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software.

Embodiments also relate to an apparatus for performing the operations disclosed herein. This apparatus may be specially constructed for the required purposes, or it may be a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled with a computer system bus. The term “coupled” may refer to two or more elements which are in direct contact (physically, electrically, magnetically, optically, etc.) or to two or more elements that are not in direct contact with each other, but still cooperate and/or interact with each other.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, embodiments are not described with reference to any particular programming language. It will be appreciated that a variety of programming languages may be used to implement the teachings of the embodiments as described herein.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems which are not directly discussed.

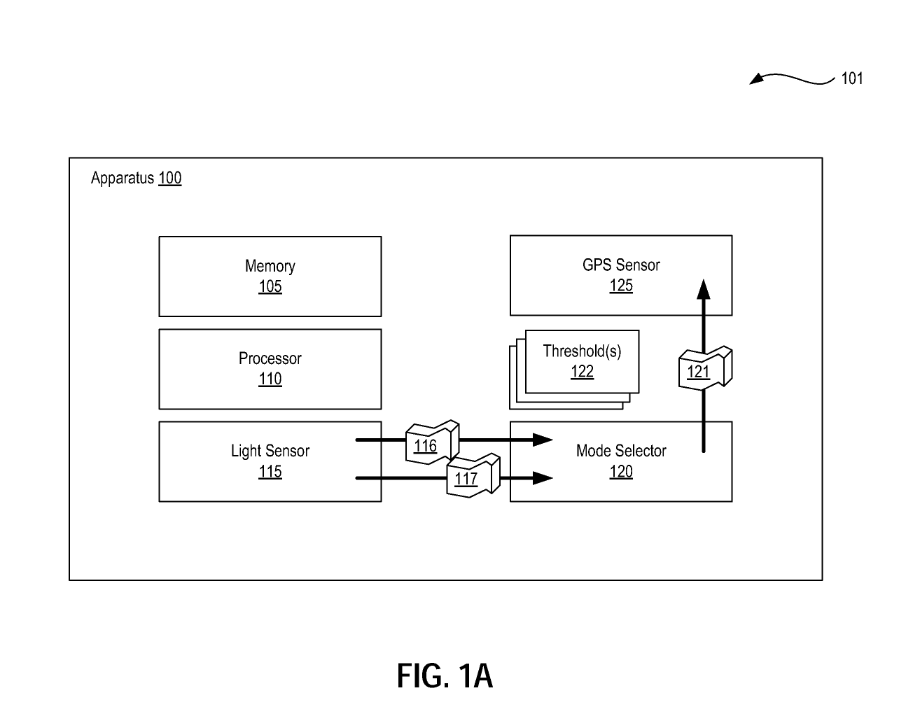

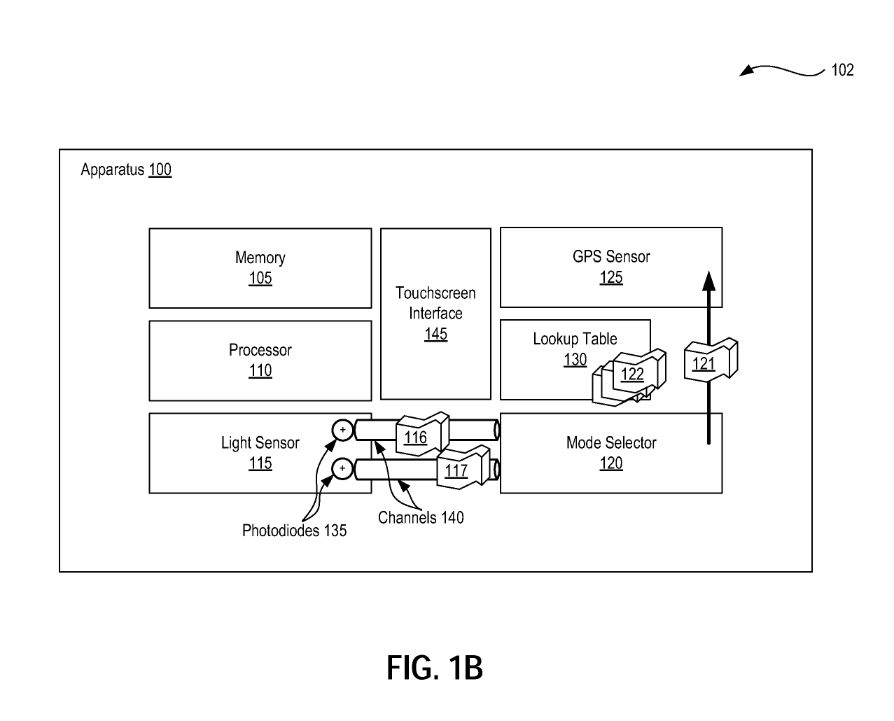

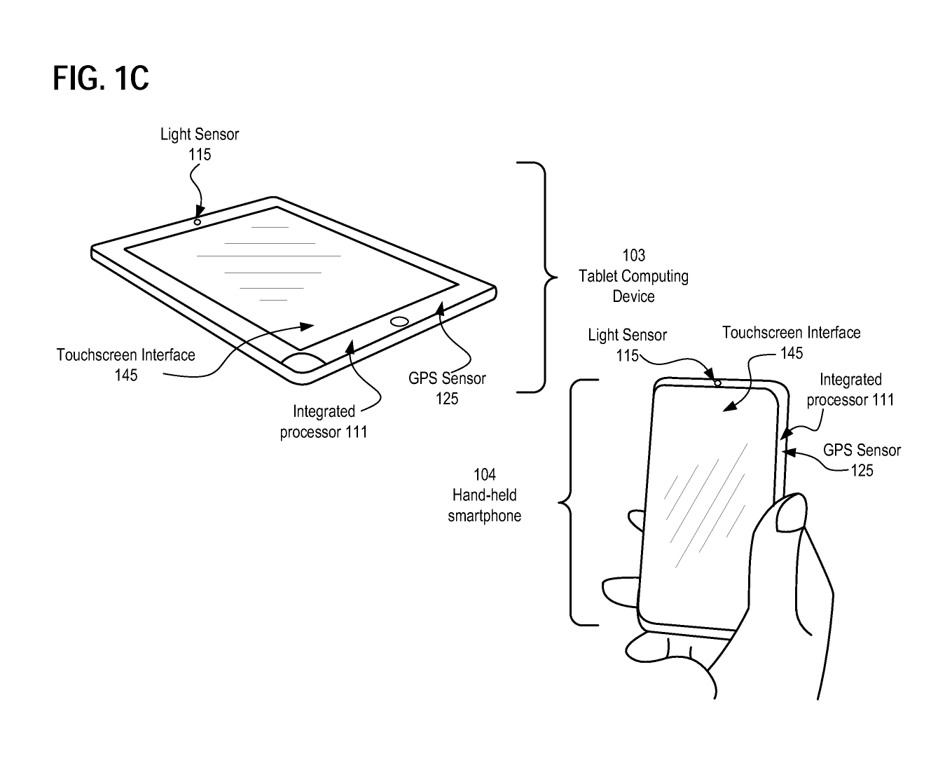

FIG. 1A illustrates an exemplary architecture 101 in accordance with which embodiments may operate. In accordance with the described embodiments, the depicted architecture 101 implements GPS power savings by detecting indoor use.

As depicted, apparatus 100 includes a memory 105, a processor 110, and a light sensor 115 which outputs readings 116 and 117. Further depicted is mode selector 120 which may send a signal 121 to GPS sensor 125 and which may further reference one or more thresholds 122. The signal 121 may be instructions for the GPS sensor 125 to transition to and from a power savings mode.

In accordance with one embodiment, such an apparatus 100 receives a first reading 116 of light within a visible spectrum of electromagnetic radiation; receives a second reading 117 of light within an infrared spectrum of electromagnetic radiation; selects an indoor environmental state when (a) the first reading 116 of light within the visible spectrum of electromagnetic radiation is above a first threshold 122 and (b) the second reading 117 of light within the infrared spectrum of electromagnetic radiation is below a second threshold 122; and transitions a Global Positioning System (GPS) sensor 125 to a power savings mode based on the indoor environmental state being selected.

Firmware or the driver for the various sensors may therefore use the level of infrared light to determine if the device is indoors. The presence of high ambient light levels but low infrared light would indicate the light is from an artificial light source and not sunlight. The platform can then safely turn off the GPS sensor or transition it into a lower power level and then maintain previously received location information for the GPS or transition location determination to another data source, such as WiFi correlation or IP address look up. The GPS sensor can then be automatically turned back on or woken from a power saving mode when the device detects it is outdoors using the same logic.

FIG. 1B illustrates an alternative exemplary architecture 102 in accordance with which embodiments may operate. Further depicted are photodiodes 135, channels 140, and lookup table 130 having thresholds 122 therein.

In accordance with one embodiment, an apparatus 100 includes a memory 105, a processor 110; a touchscreen interface 145; a light sensor 115 having a first channel 140 to output a first reading 116 of light within a visible spectrum of electromagnetic radiation and a second channel 140 to output a second reading 117 of light within an infrared spectrum of electromagnetic radiation. In such an embodiment, the apparatus 100 further includes a mode selector 120 to select an indoor environmental state when (a) the first reading 116 of light within the visible spectrum of electromagnetic radiation is above a first threshold 122 and when (b) the second reading 117 of light within the infrared spectrum of electromagnetic radiation is below a second threshold 122. Further depicted is the GPS sensor 125 which is to transition into a power savings mode based on the indoor environmental state being selected.

In accordance with one embodiment, the light sensor 115 includes a first photodiode 135 coupled with the first channel 140 and a second photodiode 135 coupled with the second channel 140. In alternative embodiments, a single photodiode 135 may be used when capable to output onto first and second channels 140 respectively for the visible and infrared spectra ranges. Other types of photodetectors may be for converting light into a current or a voltage or some other output upon which the mode selector 120 can make an appropriate assessment and selection of an operational environmental state.

In accordance with one embodiment, the first reading 116 is received at a mode selector 120 from a first channel 140 of a light sensor 115 which provides output representative of the visible spectrum and the second reading 117 is received from a second channel 140 of the light sensor 115 which provides output representative of the infrared spectrum.

In one embodiment the apparatus 100 further includes a lookup table 130 having the threshold values 122 therein. The lookup table 130 may be used to correlate output values of the first and second readings 116 and 117 to the respective threshold values 122 to be utilized. In one embodiment, the apparatus 100 further searches lookup table 130 for each of the first and second readings 116-117 to determine the first and second thresholds 122. In one embodiment, the lookup table 130 includes one of: device specific values, vendor specific values, manufacturer specific values, operating system specific values, light sensor specific values, and photodiode specific values. Platform specialized tables may be necessary to get the appropriate values from a sensor reading due to changes reflecting the mechanics of a sensor, such as its position, its aperture, its orientation to the rest of the phone, etc. In an alternative embodiment, the apparatus 100 calculates each of the first and second thresholds 122 using a correction factor based on one or more of: device specific values, vendor specific values, manufacturer specific values, operating system specific values, light sensor specific values, and photodiode specific values. In such an embodiment, the apparatus 100 may further compare the first and second reading 116-117 values to the calculated first and second thresholds 122.

In an alternative embodiment, the apparatus selects the indoor environmental state based further on a calculated delta between the first and second readings 116-117 or based further on a ratio between the first and second readings 116-117.

FIG. 1C depicts a tablet computing device 103 and a hand-held smartphone 104 each having a circuitry, components, and functionality integrated therein as described in accordance with the embodiments. As depicted, each of the tablet computing device 103 and the hand-held smartphone 104 include a touchscreen interface 145 and an integrated processor 111 in accordance with disclosed embodiments.

For example, in one embodiment, the apparatus 100 depicted at FIGS. 1A and 1B is embodied by a tablet computing device 103 or a hand-held smartphone 104, in which a display unit of the apparatus includes the touchscreen interface 145 for the tablet or smartphone and further in which memory and an integrated circuit operating as an integrated processor 111 are incorporated into the tablet or smartphone. In such an embodiment, the integrated processor 111 coordinates techniques for saving GPS power by detecting indoor use via a light sensor 115 and the mode selector 120 as described above.

In one embodiment, the GPS sensor is embodied within one of a tablet computing device 103 or a hand-held smartphone 104. In one embodiment, transitioning the GPS sensor 125 to the power savings mode includes one of: forcing the GPS sensor 125 to power down without user intervention; powering down the GPS sensor 125 based on an affirmative response to a user prompt to a display screen or touchscreen interface 145 of the tablet computing device 103 or hand-held smartphone 104; and powering down the GPS sensor 125 based on a user configurable option within the tablet computing device 103 or hand-held smartphone 104.

In accordance with one embodiment, the tablet computing device 103 or hand-held smartphone 104 provides a Graphical User Interface (GUI) upon which various user controls are provided. In one embodiment, tablet computing device 103 or hand-held smartphone 104 reads a sensitivity value from a user adjustable sensitivity slider controlled via a display screen or touchscreen interface 145 of the tablet computing device or smartphone. In such an embodiment, the first and second thresholds 122 are adjusted based on the sensitivity value to increase or decrease the probability of selecting the indoor environmental state and transitioning the GPS sensor 125 to the power savings mode responsive to the sensitivity value. For example, a user control may be provided so that the tablet computing device 103 or hand-held smartphone 104 can be made more likely or less likely from default settings to transition into a power savings mode for the GPS sensor 125. The sensitivity value can be used to adjust or recalculate the threshold values, for example, by applying a correction factor.

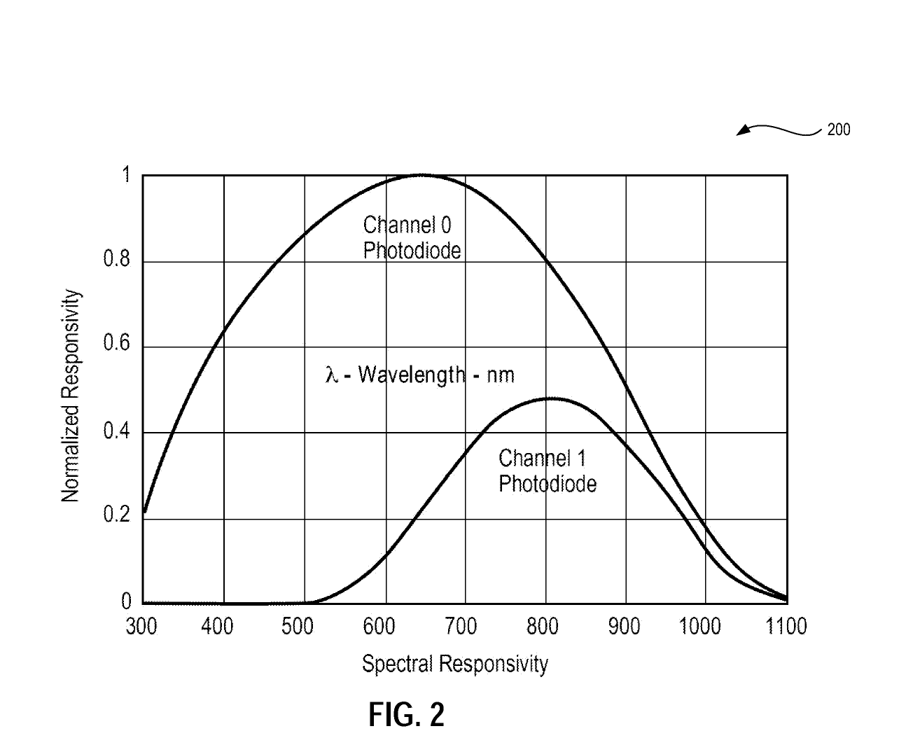

FIG. 2 illustrates a responsivity graph 200 in accordance with which embodiments may operate. The responsivity graph 200 depicts additional detail regarding the information which may be output by a light sensor for use by the mode selector. The graph is not necessarily calibrated to the exemplary apparatus 100 and is not necessarily to scale, but is nevertheless helpful in aiding understanding of the various inputs received and utilized by a mode selector in making a selection.

Depicted on the horizontal axis is the spectral responsivity ranging from 300 nanometers through 1100 nanometers. Along the vertical axis is an exemplary scale of normalized responsivity ranging from “0” through “1.” As can be seen from the graph, a first channel identified as “channel 0 photodiode” provides a first reading and may correspondingly yield a first normalized responsivity. In this depiction, the channel 0 photodiode may be better aligned, and thus, exhibit better detection characteristics of spectra in the visible spectrum because the curve is skewed further left on the scale toward the human visible range of light. The second channel which is identified as “channel 1 photodiode” provides a second reading and may correspondingly yield a second normalized responsivity. In this depiction, the channel 1 photodiode may be better aligned, and thus, exhibit better detection characteristics of spectra in the infrared, and thus, non-visible spectrum, because the curve is skewed further right on the scale toward longer wavelengths, much of which is beyond the human visible range of light. As depicted, some overlap may exist, but channel 0 is nevertheless capable to measure within a human visible range of spectra and channel 1 is nevertheless capable to measure within an infrared range of spectra.

In one embodiment, the first reading 116 of light within the visible spectrum of electromagnetic radiation includes a first value representative of energy measured within a range of wavelengths visible to a human eye at approximately 390 to 750 nanometers. In such an embodiment, the second reading 117 of light within the infrared spectrum of electromagnetic radiation includes a second value representative of energy measured at wavelengths greater than 750 nanometers and invisible to the human eye. Infrared (IR) light is electromagnetic radiation with a wavelength longer than that of visible light, measured from the nominal edge of visible red light and includes most of the thermal radiation emitted by objects near room temperature.

The light sensor 115 may provide normalized responsivity as its output readings. Thus, in accordance with one embodiment, the first reading 116 and the second reading 117 correspond to a first value of normalized responsivity to visible spectra and a second value of normalized responsivity to invisible infrared spectra respectively. Accordingly, the mode selector 120 may receive the first and second values of normalized responsivity. Responsivity measures the input-output gain of a detector system. In the specific case of a photodetector, responsivity measures the electrical output per optical input. The responsivity of a photodetector is usually expressed in units of either amperes or volts per watt of incident radiant power. For a system that responds linearly to its input, there is a unique responsivity. For nonlinear systems, the responsivity is the local slope (derivative). Photodetectors may respond linearly as a function of the incident power. Thus, responsivity is a function of the wavelength of the incident radiation and of the sensor properties, such as the bandgap of the material of which the photodetector is made. Threshold values 122 upon which the readings 116-117 are compared may therefore be customized so as to account for different types of photodetectors, such as those within varying light sensor 115 implementations or different properties associated with distinct devices and other distinguishing characteristics.

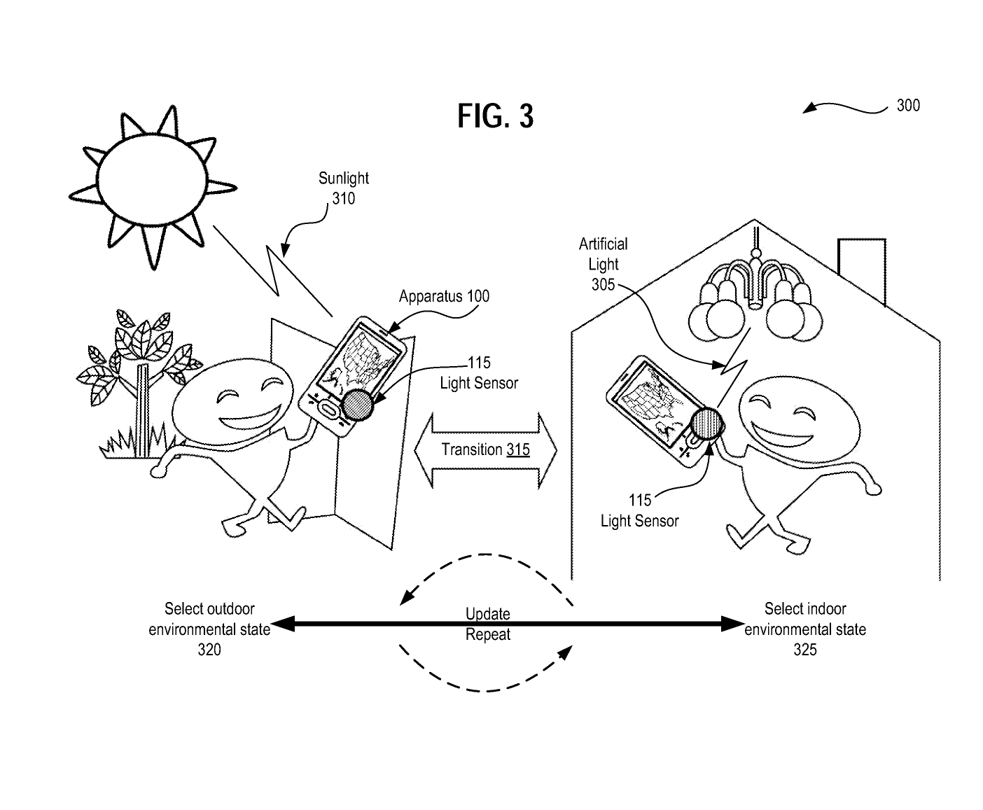

FIG. 3 illustrates an alternative exemplary embodiment 300. As depicted a transition 315 occurs based on the apparatus 100 using light sensor 115 to select an outdoor environmental state 320 or select an indoor environmental state 325 given the readings of sunlight 310 and artificial light 305.

In accordance with one embodiment, the apparatus 100 selects an outdoor environmental state 320 when the first reading 116 of light within the visible spectrum of electromagnetic radiation is above the first threshold 122 and the second reading 117 of light within the infrared spectrum of electromagnetic radiation is above the second threshold 122 (e.g., likely outdoors due to the presence of high infrared indicating high sunlight 310). The apparatus 100 selects the outdoor environmental state 320 when the first reading of light within the visible spectrum of electromagnetic radiation is above a first threshold and the second reading of light within the infrared spectrum of electromagnetic radiation is below a second threshold 122 (e.g., likely indoors due to the presence of low infrared indicating low sunlight 310 and high visible spectra indicating high artificial light 305). In one embodiment the apparatus 100 selects an unknown environmental state when the first reading 116 of light within the visible spectrum of electromagnetic radiation is below the first threshold 122 and the second reading 117 of light within the infrared spectrum of electromagnetic radiation is below the second threshold 122 (e.g., likely dark because low infrared and low visible spectra). The environmental state may be determined as unknown when it cannot be determined whether the apparatus 100 is indoors in a dark environment or outdoors in a dark environment. Accordingly, the GPS sensor may be maintained at full power when switched on. For example, the user may wish to use GPS navigation at night, and thus, the inability to determine whether the apparatus is indoors or outdoors would not be an appropriate trigger to switch the GPS sensor into a power savings mode.

In one embodiment the apparatus 100 determines a measurable presence of energy emitted from fluorescent or artificial lights 305 based on the first reading 116 of light within the visible spectrum of electromagnetic radiation being above the first threshold or determine an absence of measurable energy emitted from fluorescent or artificial light 305 based on the first reading 116 of light within the visible spectrum of electromagnetic radiation being below the first threshold. The apparatus 100 may further determine a measurable presence of sunlight energy based on the second reading 117 of light within the infrared spectrum of electromagnetic radiation being above the second threshold or determine an absence of measurable sunlight energy based on the second reading 117 of light within the infrared spectrum of electromagnetic radiation being below the second threshold.

All of the above features may be iteratively processed by the apparatus 100. Thus, in accordance with one embodiment, apparatus 100 periodically re-receives the first and second readings 116-117 and maintains the GPS sensor 125 in the power savings mode or exits the power savings mode based on the re-received first and second readings 116-117. In another embodiment, the apparatus 100 further selects an outdoor environmental state 320 based on updated first and second readings 116-117 and exits the GPS sensor 125 from the power savings mode based on the outdoor environmental state 320 being selected.

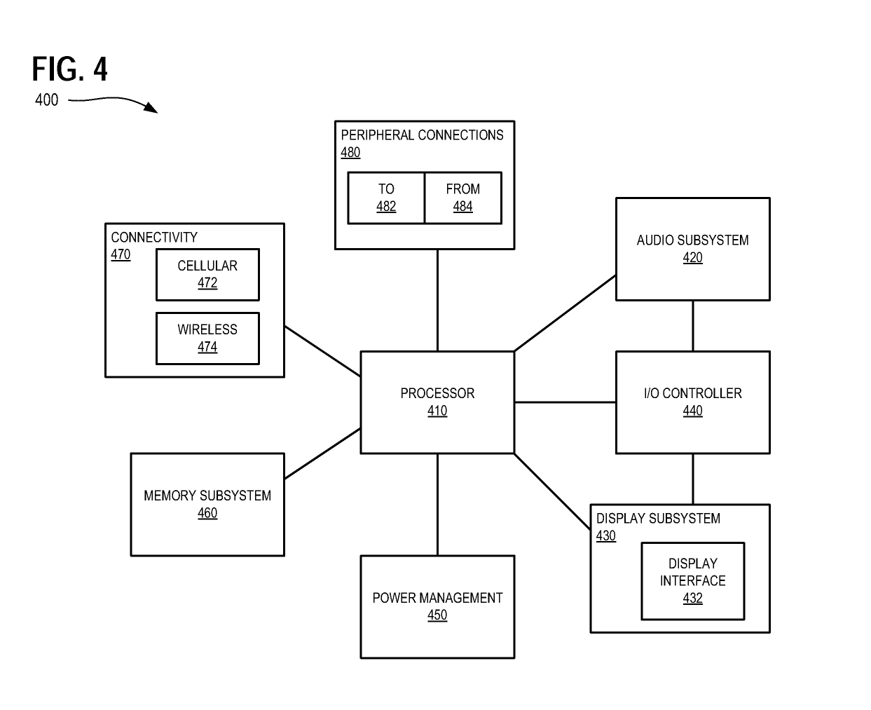

FIG. 4 is a block diagram 400 of an embodiment of tablet computing device, a smart phone, or other mobile device in which touchscreen interface connectors are used. Processor 410 performs the primary processing operations. Audio subsystem 420 represents hardware (e.g., audio hardware and audio circuits) and software (e.g., drivers, codecs) components associated with providing audio functions to the computing device. In one embodiment, a user interacts with the tablet computing device or smart phone by providing audio commands that are received and processed by processor 410.

Display subsystem 430 represents hardware (e.g., display devices) and software (e.g., drivers) components that provide a visual and/or tactile display for a user to interact with the tablet computing device or smart phone. Display subsystem 430 includes display interface 432, which includes the particular screen or hardware device used to provide a display to a user. In one embodiment, display subsystem 430 includes a touchscreen device that provides both output and input to a user.

I/O controller 440 represents hardware devices and software components related to interaction with a user. I/O controller 440 can operate to manage hardware that is part of audio subsystem 420 and/or display subsystem 430. Additionally, I/O controller 440 illustrates a connection point for additional devices that connect to the tablet computing device or smart phone through which a user might interact. In one embodiment, I/O controller 440 manages devices such as accelerometers, cameras, light sensors or other environmental sensors, or other hardware that can be included in the tablet computing device or smart phone. The input can be part of direct user interaction, as well as providing environmental input to the tablet computing device or smart phone.

In one embodiment, the tablet computing device or smart phone includes power management 450 that manages battery power usage, charging of the battery, and features related to power saving operation. Memory subsystem 460 includes memory devices for storing information in the tablet computing device or smart phone. Connectivity 470 includes hardware devices (e.g., wireless and/or wired connectors and communication hardware) and software components (e.g., drivers, protocol stacks) to the tablet computing device or smart phone to communicate with external devices. Cellular connectivity 472 may include, for example, wireless carriers such as GSM (global system for mobile communications), CDMA (code division multiple access), TDM (time division multiplexing), or other cellular service standards). Wireless connectivity 474 may include, for example, activity that is not cellular, such as personal area networks (e.g., Bluetooth), local area networks (e.g., WiFi), and/or wide area networks (e.g., WiMax), or other wireless communication.

Peripheral connections 480 include hardware interfaces and connectors, as well as software components (e.g., drivers, protocol stacks) to make peripheral connections as a peripheral device (“to” 482) to other computing devices, as well as have peripheral devices (“from” 484) connected to the tablet computing device or smart phone, including, for example, a “docking” connector to connect with other computing devices. Peripheral connections 480 include common or standards-based connectors, such as a Universal Serial Bus (USB) connector, DisplayPort including MiniDisplayPort (MDP), High Definition Multimedia Interface (HDMI), Firewire, etc.

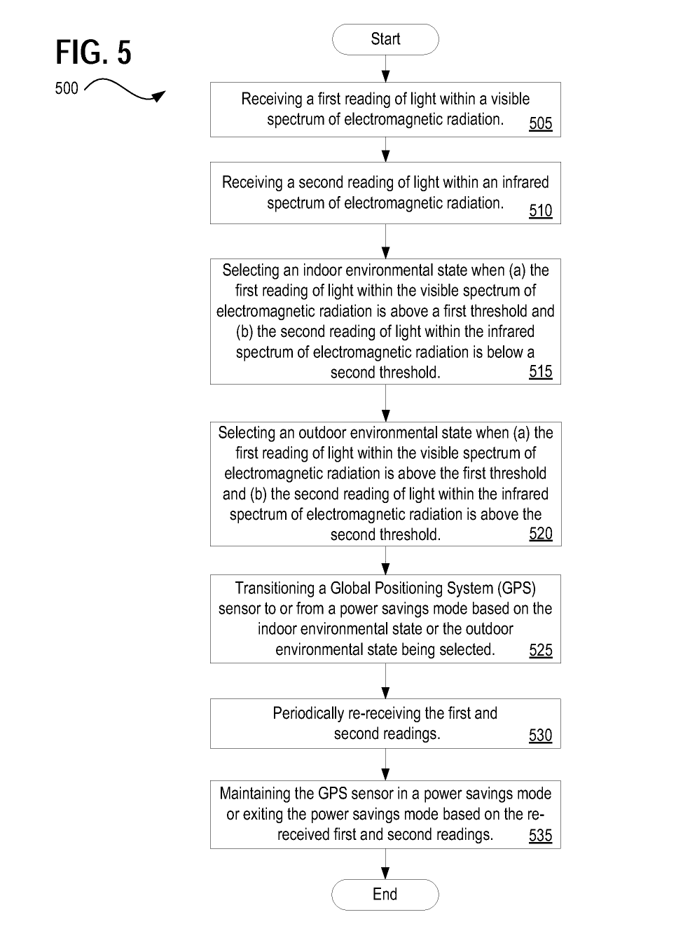

FIG. 5 is a flow diagram illustrating a method 500 for saving GPS power by detecting indoor use. Method 500 may be performed by processing logic that may include hardware (e.g., circuitry, dedicated logic, programmable logic, microcode, etc.). The numbering of the blocks presented is for the sake of clarity and is not intended to prescribe an order of operations in which the various blocks must occur.

Method 500 begins with processing logic for receiving a first reading of light within a visible spectrum of electromagnetic radiation (block 505).

At block 510, processing logic receives a second reading of light within an infrared spectrum of electromagnetic radiation.

At block 515, processing logic selects an indoor environmental state when (a) the first reading of light within the visible spectrum of electromagnetic radiation is above a first threshold and (b) the second reading of light within the infrared spectrum of electromagnetic radiation is below a second threshold.

At block 520, processing logic selects an outdoor environmental state when (a) the first reading of light within the visible spectrum of electromagnetic radiation is above the first threshold and (b) the second reading of light within the infrared spectrum of electromagnetic radiation is above the second threshold.

At block 525, processing logic transitions a Global Positioning System (GPS) sensor to or from a power savings mode based on the indoor environmental state or the outdoor environmental state being selected.

At block 530, processing logic periodically re-receives or updates the first and second readings.

At block 535, processing logic maintains the GPS sensor in a power savings mode or exiting the power savings mode based on the re-received first and second readings.

In accordance with one embodiment, there is a non-transitory computer readable storage medium having instructions stored thereon that, when executed by a processor, the instructions cause a tablet computing device or smartphone to perform operations including: receiving a first reading of light within a visible spectrum of electromagnetic radiation; receiving a second reading of light within an infrared spectrum of electromagnetic radiation; selecting an indoor environmental state when (a) the first reading of light within the visible spectrum of electromagnetic radiation is above a first threshold and (b) the second reading of light within the infrared spectrum of electromagnetic radiation is below a second threshold; and transitioning a Global Positioning System (GPS) sensor to a power savings mode based on the indoor environmental state being selected.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

1. A method comprising:
receiving a first reading of light within a visible spectrum of electromagnetic radiation;
receiving a second reading of light within an infrared spectrum of electromagnetic radiation;
selecting an indoor environmental state when (a) the first reading of light within the visible spectrum of electromagnetic radiation is above a first threshold and (b) the second reading of light within the infrared spectrum of electromagnetic radiation is below a second threshold; and
transitioning a Global Positioning System (GPS) sensor to a power savings mode based on the indoor environmental state being selected.

2. The method of claim 1:
wherein receiving the first reading comprises receiving the first reading from a first channel of a light sensor which provides output representative of the visible spectrum; and
wherein receiving the second reading comprises receiving the second reading from a second channel of the light sensor which provides output representative of the infrared spectrum.

3. The method of claim 2, wherein the light sensor comprises:
a first photodiode coupled with the first channel; and
a second photodiode coupled with the second channel.

4. The method of claim 1, wherein the first reading of light within the visible spectrum of electromagnetic radiation comprises a first value representative of energy measured within a range of wavelengths visible to a human eye at approximately 390 to 750 nanometers.

5. The method of claim 4, wherein the second reading of light within the infrared spectrum of electromagnetic radiation comprises a second value representative of energy measured at wavelengths greater than 750 nanometers and invisible to the human eye.

6. The method of claim 1, wherein receiving the first reading and receiving the second reading comprises receiving a first value of normalized responsivity to visible spectra and a second value of normalized responsivity to invisible infrared spectra.

7. The method of claim 1, further comprising:
searching a lookup table for each of the first and second readings to determine the first and second thresholds, wherein the lookup table comprises one of: device specific values, vendor specific values, manufacturer specific values, operating system specific values, light sensor specific values, and photodiode specific values.

8. The method of claim 1, further comprising:
calculating each of the first and second thresholds using a correction factor based on one or more of: device specific values, vendor specific values, manufacturer specific values, operating system specific values, light sensor specific values, and photodiode specific values; and
comparing the first and second values to the calculated first and second thresholds.

9. The method of claim 1, wherein selecting the indoor environmental state is based further on a calculated delta between the first and second readings or a ratio between the first and second readings.

10. The method of claim 1, further comprising:
selecting an outdoor environmental state when the first reading of light within the visible spectrum of electromagnetic radiation is above the first threshold and the second reading of light within the infrared spectrum of electromagnetic radiation is above the second threshold; and
selecting an unknown environmental state when the first reading of light within the visible spectrum of electromagnetic radiation is below the first threshold and the second reading of light within the infrared spectrum of electromagnetic radiation is below the second threshold.

11. The method of claim 1, wherein the GPS sensor is embodied within one of a tablet computing device or a smartphone.

12. The method of claim 11, wherein transitioning the GPS sensor to the power savings mode comprises one of:
forcing the GPS sensor to power down without user intervention;
powering down the GPS sensor based on an affirmative response to a user prompt to a display screen of the tablet computing device or smartphone; and
powering down the GPS sensor based on a user configurable option within the tablet computing device or smartphone.

13. The method of claim 12, further comprising:
reading a sensitivity value from a user adjustable sensitivity slider controlled via a display screen of the tablet computing device or smartphone; and
adjusting the first and second thresholds based on the sensitivity value to increase or decrease the probability of selecting the indoor environmental state and transitioning the GPS sensor to the power savings mode responsive to the sensitivity value.

14. The method of claim 1, further comprising:
determining a measurable presence of energy emitted from fluorescent lights based on the first reading of light within the visible spectrum of electromagnetic radiation being above the first threshold;
determining an absence of measurable energy emitted from fluorescent lights based on the first reading of light within the visible spectrum of electromagnetic radiation being below the first threshold;
determining a measurable presence of sunlight energy based on the second reading of light within the infrared spectrum of electromagnetic radiation being above the second threshold; and
determining an absence of measurable sunlight energy based on the second reading of light within the infrared spectrum of electromagnetic radiation being below the second threshold.

15. The method of claim 1, further comprising:
periodically re-receiving the first and second readings; and
maintaining the GPS sensor in the power savings mode or exiting the power savings mode based on the re-received first and second readings.

16. The method of claim 1, further comprising:
selecting an outdoor environmental state based on updated first and second readings; and
exiting the GPS sensor from the power savings mode based on the outdoor environmental state being selected.

17. A computing device comprising:
a memory;
a processor;
a light sensor having a first channel to output a first reading of light within a visible spectrum of electromagnetic radiation and a second channel to output a second reading of light within an infrared spectrum of electromagnetic radiation;
a mode selector to select an indoor environmental state when (a) the first reading of light within the visible spectrum of electromagnetic radiation is above a first threshold and (b) the second reading of light within the infrared spectrum of electromagnetic radiation is below a second threshold; and
a Global Positioning System (GPS) sensor to transition into a power savings mode based on the indoor environmental state being selected.

18-26. (canceled)

27. The computing device of claim 17, wherein the light sensor comprises:
a first photodiode coupled with the first channel;
a second photodiode coupled with the second channel; and
wherein the GPS sensor to transition into the power savings mode according to one of the following transition models:
force the GPS sensor to power down without user intervention,
power down the GPS sensor based on an affirmative response to a user prompt to a display screen of the computing device, and
power down the GPS sensor based on a user configurable option within the computing device.

28. At least one machine readable medium comprising a plurality of instructions that in response to being executed on a computing device, cause the computing device to carry out operations including:
receiving a first reading of light within a visible spectrum of electromagnetic radiation;
receiving a second reading of light within an infrared spectrum of electromagnetic radiation;
selecting an indoor environmental state when (a) the first reading of light within the visible spectrum of electromagnetic radiation is above a first threshold and (b) the second reading of light within the infrared spectrum of electromagnetic radiation is below a second threshold; and
transitioning a Global Positioning System (GPS) sensor to a power savings mode based on the indoor environmental state being selected.

29. The at least one machine readable medium of claim 28:
wherein receiving the first reading comprises receiving the first reading from a first channel of a light sensor which provides output representative of the visible spectrum; and
wherein receiving the second reading comprises receiving the second reading from a second channel of the light sensor which provides output representative of the infrared spectrum.
